(19) United States
(12) Patent Application Publication
(10) Pub. No.: US 2002/0192836 A1
(43) Pub. Date: Dec. 19, 2002

(54) Detection of chemical agent materials using a sorbent polymer and fluorescent probe

(75) Inventors: Howard P. Groger, Gainesville, FL (US); K. Peter Lo, Blacksburg, VA (US); John Raymonda, Las Cruces, NM (US); Roger L. Reynolds, Blasdell, NY (US)

Correspondence Address: D. Douglas Price, STEPTOE & JOHNSON LLP, 1330 Connecticut Avenue, N.W., Washington, DC, 20036, US

(73) Assignee: Calspan SRL Corporation, Buffalo, NY

(21) Appl. No.: 10/073,041

(22) Filed: Feb. 12, 2002

Related U.S. Application Data
(62) Division of application No. 09/095,114, filed on Jun. 10, 1998, now abandoned.
(60) Provisional application No. 60/049,270, filed on Jun. 10, 1997.

(51) Int. Cl. G01N 21/76

(52) U.S. Cl. 436/172

(57) ABSTRACT

The present invention is a fluorescent probe for detecting chemicals, particularly chemical warfare agents. The probe has a novel selection of polymers and fluorophores that allow for laser excitation and photodiode detection of chemical warfare agents. A probe based on poly(epichlorohydrin) as the polymer and nile blue A perchlorate as the fluorophore is sensitive to concentrations of mustard of less than 30 ppb. Probes based on fluoropolyol as the polymer and oxazine 170 perchlorate as the fluorophore is sensitive to low concentrations of soman. Selecting a cationic fluorophore that has an affinity for the chemical agent of interest and immobilizing that fluorophore in a polymer matrix provides a fluorescent probe capable of detecting the presence of the desired chemical agent in trace quantities. A set of probes may be used so that in the presence of an analyte or a mix of analytes one or more of the probes may be responsive.

This is a divisional application of Ser. No. 09/095,114, filed Jun. 10, 1998, now abandoned, which is a complete application of provisional application Ser. No. 60/049,270, filed Jun. 10, 1997.

### SUMMARY OF THE INVENTION

A novel selection of polymers and fluorophores is presented allowing diode laser interrogation and photodiode detection of chemical warfare agents. In particular, two combinations of polymers and fluorophores are disclosed that allow detection of mustard gas and soman at low part-per-billion concentrations.

A fluorescent probe for detecting chemicals comprises a polymer and a fluorophore embedded in the polymer. The probe may have a solvent that is absorbed by the polymer.

The polymer may be selected from a group consisting of but not limited to PIB Poly(isobutylene), SXPH 75% phenyl-25% methylpolysiloxane, PEM polyethylene maleate), SXCN Poly bis(cyanopropyl) siloxane, PVTD poly (vinyltetradecanal) PECH poly(epichlorohydrin), PVPR poly(vinyl propionate) OV202 poly(trifluoropropyl) methyl siloxane, P4V poly(4-vinylhexafluorocumyl alcohol), SXFA 1-(4-hydroxy, 4-trifluoromethyl,5,5,5-trifluoro)pentene methylpolysiloxane, FPOL fluoropolyol, ZDOL Fomblin Z-dol, PEI Poly(ethyleneimine), SXPYR alkylaminopyridyl-substituted siloxane.

The fluorophore may be selected from a group consisting of but not limited to Nile blue A Perchlorate, oxazine 170, oxazine 720, oxazine 750, 1,3-Bis(4-(dimethylamino)-2-hydroxyphenyl)-2,4-dihydroxycyclobutenediylium dihydroxide, bis(inner salt), diethylthidadicarbocyanine iodide, hexamethylindotricarbo-cyanine iodide (HITC), Indocyanine Green, New Indocyanine Green, Diethylthia-tricarbocyanine iodide (DTTC) , perchlorate, IR-780 Perchlorate, Methylene Blue, hexamethylindodicarbocyanine (DiIC₁(5)).

A probe based on fluoropolyol, where the fluorophore is oxazine 170 perchlorate, is sensitive to soman (GD).

A probe based on poly(epichlorohydrin) (PECH), where the solvent is ethanol and the fluorophore is nile blue A perchlorate, is sensitive to trace quantities of mustard (HD).

In another preferred embodiment, a set of probes are used so that in the presence of an analyte or a mix of analytes one or more of the probes may be responsive.

These and further and other objects and features of the invention are apparent in the disclosure, which includes the above and ongoing written specification, with the claims and the drawings.

### BRIEF DESCRIPTION OF THE DRAWINGS

FIG. 1 is a graph of the emission spectra of Nafion thin film containing DiIC₁(5) before and after exposure to DMMP vapor.

FIG. 2 is a graph of the sensitivity and proportionality of a Nafion/DiIC₁(5) probe to DMMP.

FIG. 3 is a graph of the response of Nile Blue doped polyethylene maleate films to DMMP.

FIG. 4 is a graph of the response of Nile Red doped polyethylene maleate films to DMMP.

FIG. 5 is a graph of the change of fluorescence of DiIC₁(5) in Nafion upon exposure to Sarin at 0.0099 mg/m³.

FIG. 6 is a graph of the change of fluorescence intensity Nile Blue when the film was exposed to Sarin.

FIG. 7 is a graph of the response of Oxazine 170/Fluoropolyol film to GD at 520 ppb.

FIG. 8 is a graph of the response of Oxazine 170/Fluoropolyol film to GD at 41 ppb.

FIGS. 9A, 9B and 9C are graphs of the response of Nile Blue/PECH film exposed to 350 ppb HD, then exposed to 166 ppb GD, and then exposed to 243 ppb HD, respectively.

FIG. 10 is a diagram of the synthesis of near-infrared excited solvatochromic fluorophore.

FIG. 11 is a diagram of the synthesis of aryl near-infrared excited solvatochromic fluorophore.

FIG. 12 is a diagram of hydrogen bonding to keto-enol structures.

FIG. 13 is a diagram of possible heteroatom substitutions for keto-enol dye.

### DETAILED DESCRIPTION OF THE PREFERRED EMBODIMENTS

Optical methods of detecting organophosphorus-based nerve agent materials have been reviewed by Crompton (1987). One of the best calorimetric methods for detection of organophosphorus halides involves the use of diisonitrosoacetone reagent or the monosodium salt of this material which, upon exposure to GA or Sarin (GB) at concentrations of micrograms per milliliter, produces a magenta color with maximum response within seven minutes. Chemical analysis using 3-aminophthalhydrazide (luminol) with sodium perborate has been shown to be effective in detecting as little as 0.5 micrograms of GB or GA. The use of polymer coated optical waveguides in the detection of nerve agents or simulated nerve agents such as dimethyl methylphosphonate (DMMP) has been reported by Giuliani et al. (1986), who identified polymeric materials with an affinity for the nerve agent exhibiting a change in refractive index upon absorption of the nerve agent. Several materials have been found to exhibit an affinity for DMMP. Fluoropolyol, described by Grate and Abraham (1991), was found to have a partition coefficient for vapor phase DMMP between one million and ten million, indicating that the concentration of DMMP in the fluoropolyol was up to ten million times that in the vapor phase. Fluoropolyol is strongly acidic, a factor that may improve sensitivity to strongly basic vapors, such as the organophosphorus compounds. Groger et al. (1995) found that immobilization of a wide range of cationic fluorophores in polymers having affinity for the chemical agent of interest provided a probe capable of detecting the presence of those agents at trace concentrations.

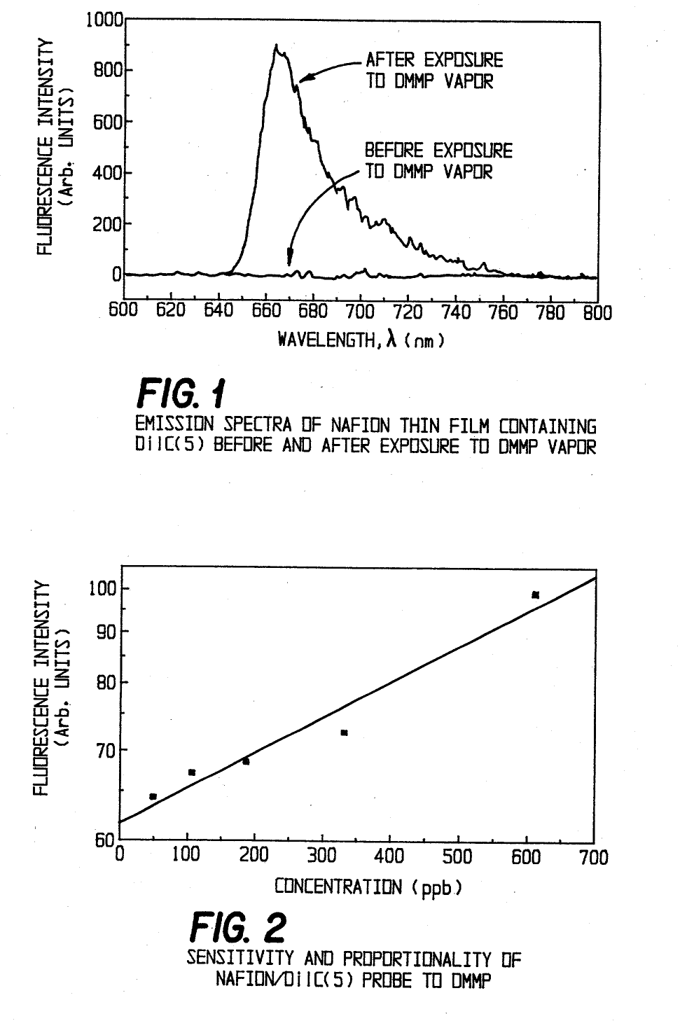

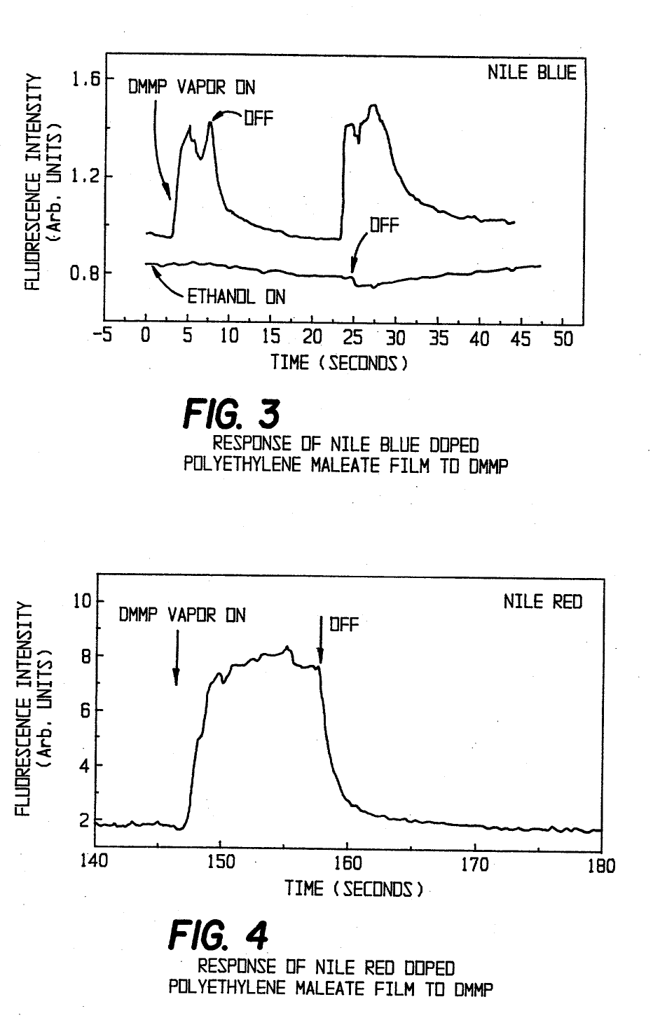

Work performed by ARCOVA under funding from the U.S. Army (Groger et al., 1995) has demonstrated the sensitivity of optical methods based on the change of fluorescence of dyes embedded in a polymer matrix when exposed to chemical vapors, including chemical agents and their simulants. Results of tests at ARCOVA using DMMP are summarized in FIGS. 1 through 4. A range of near-infrared excited fluorophores in Nafion, an ionophoric, ion exchange polymer, were found to provide nearly reversible response to DMMP at concentrations measured to 17 parts per billion. Fluorescence levels were found to increase dramatically upon exposure to DMMP vapor as shown in FIG. 1. The limit of detection (LOD) for work performed at ARCOVA was set by the lowest concentration that could be generated by the permeation tube used in the experiments. The sensitivity and linearity of the response of hexamethyl indodicarbocyanine in Nafion is shown in FIG. 2 for concentrations of DMMP varying from 50 ppb to 300 ppm. Detection and cleardown times using a range of polymers were found to vary from less than a second to several seconds as shown in FIGS. 3 and 4 for a nile red and nile blue in poly(ethylene maleate)(PEM). More recent results, obtained at the end of the above referenced Army program and under an ongoing IR&D Program funded by Calspan SRL, are summarized in the following paragraphs.

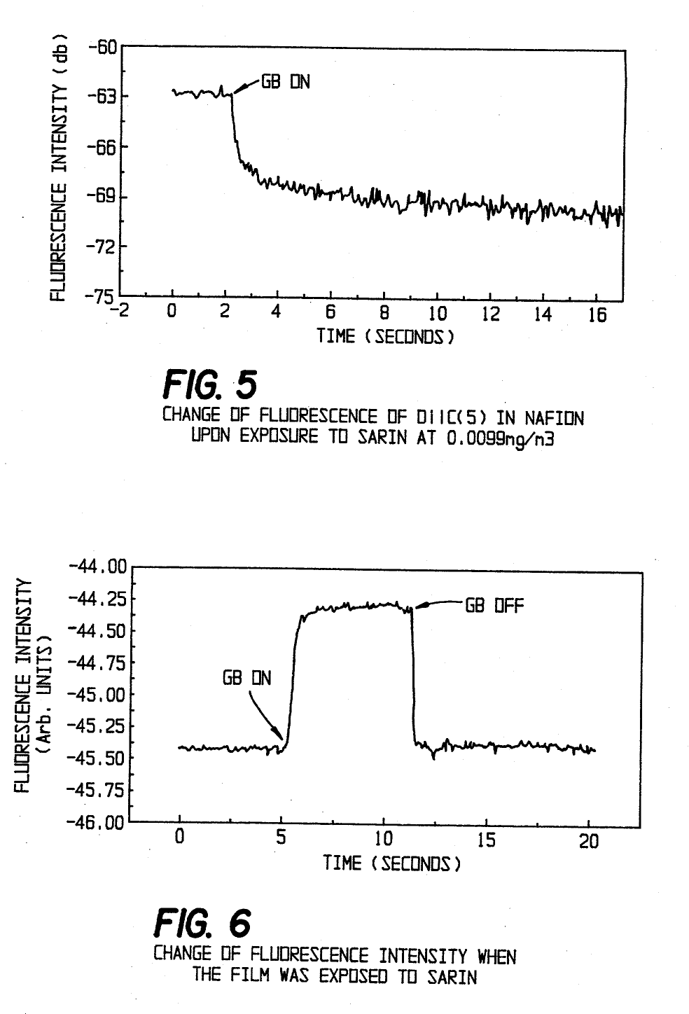

In experiments performed under the Army program at the Calspan SRL surety facility (Groger et al. 1995), films having the dye DiIC₁(5) immobilized in Nafion were exposed to GB at concentrations down to 1.6 ppb (0.0099 mg/ml) in flowing air. The results shown in FIG. 5 were obtained at 1.6 ppb. This concentration was sufficient to nearly saturate the film response. Note that about 90% of the total response was obtained in less than one second. Upon removal of the challenge and flushing with clean air, the recovery of the fluorescence level was complete (i.e., final level about −63 dB) and equally rapid. In subsequent qualitative tests, responses less than the saturation level were observed when concentrations lower than 1.6 ppb, obtained by allowing a 1.6 ppb challenge to diffuse to the film through stagnant clean air, were presented to the film. Estimates of concentrations of GB detected under those conditions suggest that the sensor could respond in the sub 500 parts-per trillion range.

The fluorescence of DiIC₁(5) decreased upon exposure to GB but, in tests performed at ARCOVA, increased upon exposure to DMMP (Groger et al., 1995). In contrast, the fluorescence of Nile Blue A increased upon exposure to GB as shown in FIG. 6. Note that response was rapid, about 1 second, and complete recovery was obtained. The differences in response directions and magnitudes exhibited by the films of FIGS. 1 and 2 together with the DMMP results at ARCOVA indicate the basis for agent identification and interferant rejection using multiple films and pattern recognition.

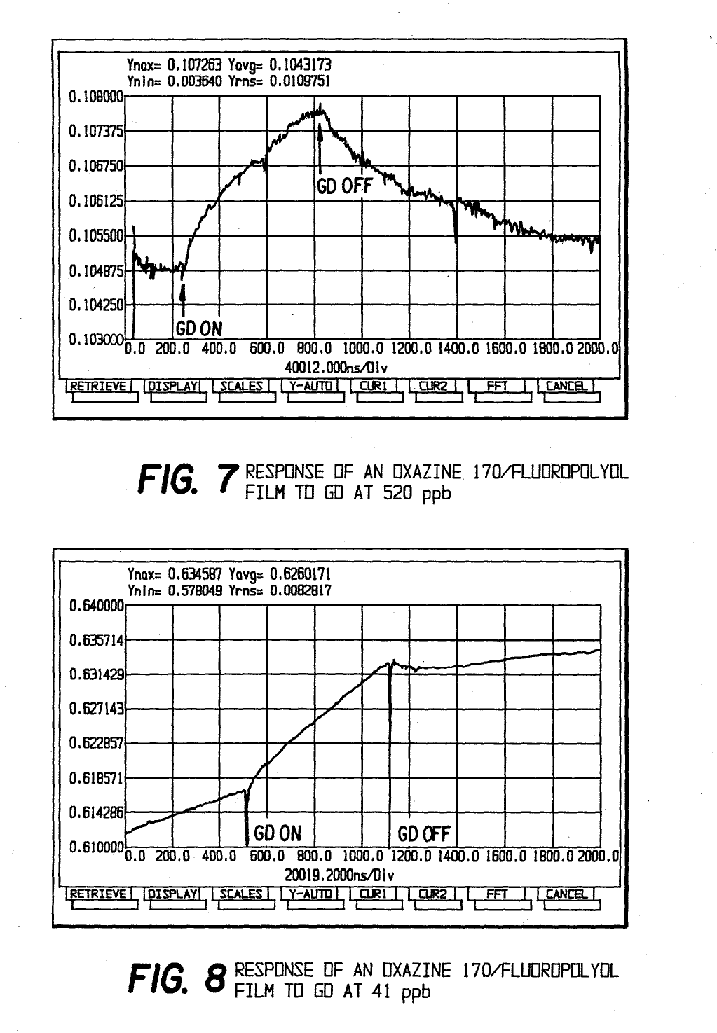

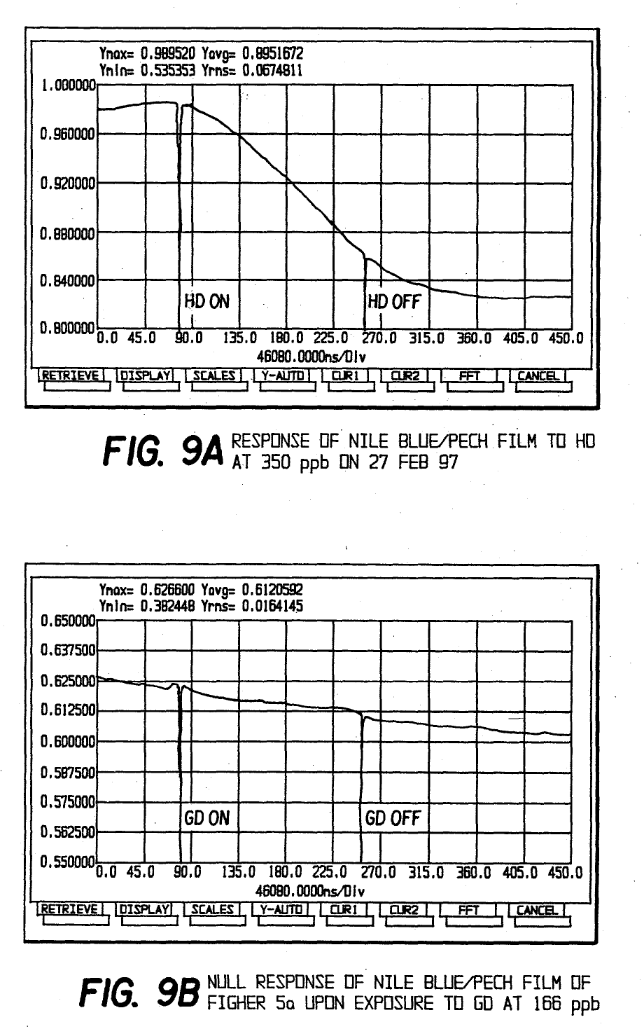

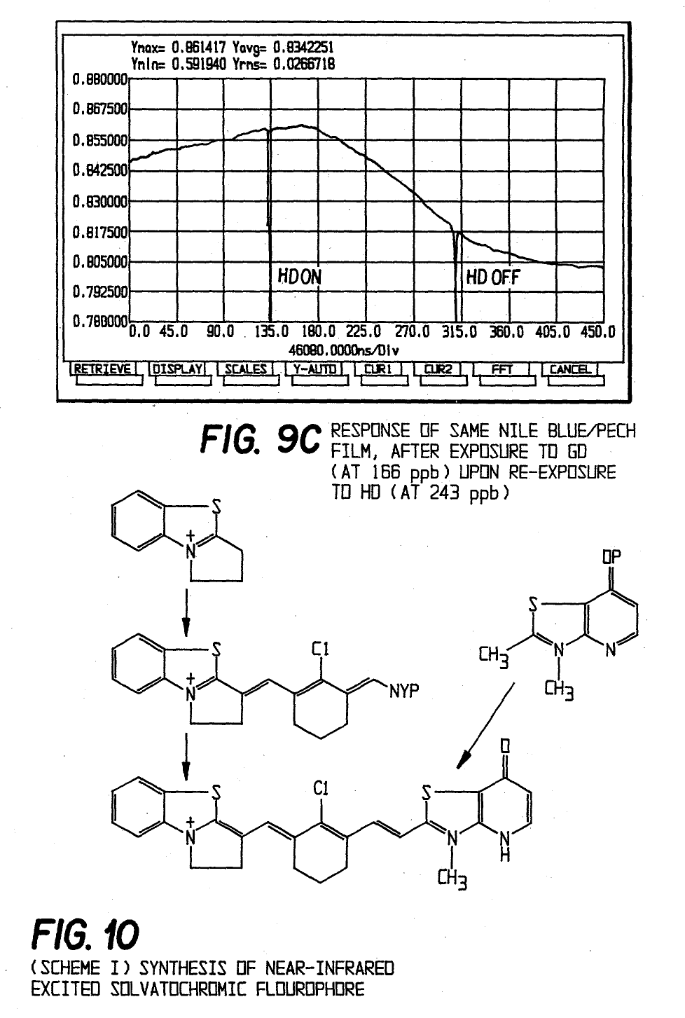

The basis for agent identification has been further strengthened in recent Calspan-funded IR&D tests designed to screen a wide range of dye/polymer combinations for response to various agents. First, a DiIC₁(5)/Nafion film, like that previously shown to have high sensitivity to GB, exhibited no response to GD. Instead, a different film, Oxazine 170 in Fluoropolyol was shown to be the most sensitive, of those tested to date, to GD. Here, GD was shown to increase the intensity of Oxazine 170 fluorescence as shown in FIGS. 7 and 8; concentrations down to 41 ppb have, so far, been used in the screening tests currently in progress. The films employed here are thicker than those that yielded the results shown in FIGS. 5 and 6 (made with more concentrated polymer solutions) and the detection and cleardown times are typically on the order of two minutes. Second, a film of the polymer PECH containing Nile Blue was shown to be sensitive to HD in concentrations of about 25 ppb. The same film was then exposed to GD with no response and then re-exposed to the same concentration of HD with essentially the same response as before the exposure to GD. This behavior is illustrated in FIGS. 9A, 9B and 9C.

The sensitivity of fluorophore-polymer films to chemical agents when evaluated using total internal reflection fluorescence (TIRF) methods results from the capability of TIRF methods to monitor very small changes in the molecular scale environment of the fluorescent probe materials. The benefits of TIRF procedures are summarized by Santore et al. (1995). The combination of TIRF procedures with suitable polymers which may concentrate the chemical agent material within the polymer to levels over one million times that found in the surrounding air provides a very powerful tool for monitoring the gaseous and aerosol environment. When multiple fluorophore-polymer films are employed, a selective detector can be produced in which the vector summation response, using pattern recognition or neural network techniques, of the TIRF signals from each fluorophore-polymer pair provides a direct measure of the type and concentration of the vapors present in the sample. The approach to selecting polymer materials for use in chemical sensors is provided by McGill et al. (1994) and is based on prediction of partition coefficient using the linear salvation energy relationship (LSER) as detailed below. The relationship between the log of the gas-polymer partition coefficient Kₚ, and a number of salvation parameters is given by

Log Kₚ=c+rR₂+Sπ^{H}₂+aα^{H}₂+bβ^{H}₂+1LogL¹⁶

where R₂ is the excess molar refraction, a term which models polarizibility contributions from n and π electrons, π^{H}₂ is the dipolarity, α^{H}₂ is the hydrogen bond acidity, β^{H}₂ is the hydrogen bond basicity, L¹⁶ is the gas-liquid partition coefficient on hexadecane and a, b, l, r and s are coefficients relating the salvation properties of the polymer to those of the vapor. The regression constant, c, is used to allow empirical fitting of the data. Coefficients for many polymeric materials have been determined using partition coefficients calculated from either surface acoustic wave instrumentation (Patrash and Zellers, 1993) or inverse gas-liquid chromatographic retention data at high temperatures in inert atmospheres (Abraham et al., 1995). It has been determined by McGill et al. (1994) that selectivity of polymeric sorbent layers can be optimized by evaluating ratios of LSER coefficients. For example, although each of the partition coefficients of fluoropolyol, 1-(4-hydroxy, 4-trifluoromethyl, 5,5,5-trifluoropentene methylpolysiloxane and poly(4-vinylhexafluorocumyl alcohol) for dimethyl methylphosphonate, a simulant for alkylphosphonate nerve agents, are relatively high, the relative magnitude of the partition coefficients are arranged in the order of the ratio of acidity to basicity as shown in Table A.

Probes Responding to Changes in Conformation of the Polymer

Considerable literature is available on the change in molecular conformation of oriented thin films in the presence of an analyte. Anzai and Osa (1990) discussed the effect of thin film orientation in chemical sensing. When the fluorophore interacts with a thin film capable of changing orientation in the presence of an analyte, the total detected fluorescence , F, can provide information on the orientation of the fluorophore. In a total internal reflection experiment, the total detected fluorescence is given by F=C((μ·E)²f(ν)) where μ is the direction of the absorption transition dipole moment of the fluorophore, ν is the direction of the emission transition dipole moment, E is the direction of the electric field component of the evanescent field, and f(ν) is the collection efficiency of the emitted light (Bos and Kleijn, 1995). The constant, C, is used to take into account the magnitudes of the absorption and emission dipole moments, the quantum efficiency and surface concentration of the fluorophore, the intensity of the evanescent field and the properties of the detection system. Since the direction of the electric field vector can be changed by altering the polarization of the incident light, it is possible to obtain information on the change in conformation of the thin film by using different polarizations of the incident light and measuring the resulting total detected fluorescence.

Probes Responding to Shrinking and Swelling of the Polymer

It is well-known that a wide range of polymers respond to changes in their local chemical environment by shrinking or swelling (Errede, 1991). A cross-linked polymer is prevented from dissolving in a compatible solvent; instead, the polymer will absorb the solvent and swell to a volume where the swelling forces due to salvation are balanced by the refractive forces associated with the stretching of the polymer linkages. The amount of swelling depends upon the affinity of the polymer for the solvent and the degree of cross-linking. A polymer containing charged ionic groups will also respond to the electrostatic forces between the charged groups. This process has been used in the development of optical fiber chemical sensors through optical measurement of displacement of surfaces of the polymer film (Seitz, 1993).

Probes Responding to Changes of the Concentration of the Analyte in the Local Environment of the Fluorophore

Polymers may serve to increase the concentration of the vapor analyte in the microenvironment of the fluorophore through the partition coefficient, K, which may be defined as the ratio of the concentration of the analyte in the polymer, Cₐₚ to the concentration of the analyte in the vapor surrounding the polymer, Cₐᵥ. The identification of polymers having especially high partition coefficients for vapors with specified physical and chemical properties has been systematized (Abraham et al., 1995 and McGill et al., 1994) by the application of the theory of Linear Solvation Energy Relationships (LSER). The partition coefficient may be determined experimentally using SAW devices through the equation

Δfᵥ=ΔfₚKₑCₐᵥ/ρₚ

where Δfᵥ is the sensor frequency shift caused by the vapor being adsorbed by the polymer, Δfₚ is the initial frequency shift caused by the deposition of the polymer, ρₚ is the polymer density and Kₑ is the experimental determination of the partition coefficient (Patrash and Zellers, 1993). Experimental values of the partition coefficient have been found to be as high as one million to ten million, indicating significant concentration of the vapor within the polymeric stationary phase. Data on Δfᵥ, occurring when nerve agent simulants are brought into contact with a range of polymers are presented by Rose-Pehrsson et al. (1988). It was found that the polymers providing the largest change in SAW response in the presence of dimethyl methylphosphonate (DMMP) and N,N,-dimethylacetamide (DMAC) included poly (isoprene/fluoro alcohol), fluoropolyol and poly (ethylene maleate). Those findings agreed, in part, with predictions reported by Chang et al. (1987) and Barlow et al. (1987) on the use of fluorinated polymers with available hydroxide functional groups to serve as sorbents for nerve agent simulants through hydrogen bonding. Barlow et al., (1987) found that the heats of mixing for DMMP with phenol, chlorophenols, chlorinated hydrocarbons and hexafluoroisopropanol were strongly exothermic, indicating potentially strong sorption on these materials. All of these compounds are proton donors or acids and the exothermic heats of mixing observed probably resulted from hydrogen bond formation. The finding that hexafluoro-isopropanol exhibited the highest exothermic heat of mixing was explained on the basis that the hydroxyl proton is activated for hydrogen bond formation by the very strong electron withdrawing character of the adjacent fluorine atoms. Barlow et al. (1987) suggested that more sensitive reagents for nerve agent simulants could be developed if the phosphorous ester could be readily soluble in the polymer backbone and if the acidity of the polymer could be increased. This has been demonstrated to some extent using a Nafion-based probe (Groger et al., 1995).

The changes in local concentration may be detected through the fluorescence of immobilized dyes. Fluorophores are available for detection of changes in solute-solvent conditions, pH, local viscosity or fluidity within a polymer structure (Valeur, 1993). One sensitive method of analyte detection involves the alteration of the fluorophore emission spectrum by specific solvent-fluorophore interactions. Specific solvent effects are reviewed by LAKOWICZ (1983). The specific solvent effect can result from hydrogen bonding, acid-base chemistry or charge transfer interactions. Those interactions may be observed using solvatochromic dyes, which exhibit a shift in emission wavelength in the presence of a solvent. Trace quantities of the solvent are sufficient to cause the greater portion of the shift in emission wavelength; additional solvent produces a much smaller additional shift per unit amount added. The example of 2-acetylanthracene in hexane is given by Lakowicz (1983). Addition of 1% methanol by volume to the hexane produces a significant shift in the fluorescence emission of the 2-acetylanthracene related to hydrogen bond formation between the carbonyl group and the alcohol during the lifetime of the excited state of the fluorophore.

Near infrared excited fluorescent dyes may be selected to respond to differing characteristics of the agent-laden matrix. Acid-base responses may be monitored using oxazine 720, oxazine 750 and Nile blue A Perchlorate. Those dyes are commercially available and have been observed to be effective in the detection of simulant materials such as dimethyl methylphosphonate. A near infrared pH-sensitive dye, 1,5-bis(p-dimethylaminophenyl)-2,4 pentadienyl carbonium Perchlorate, has been synthesized with maximum optical absorption around 780 nm (Citterio et al., 1996).

Probes for changes in polymer thickness, salvation parameters or fluidity include malachite green (Abedin et al., 1995), the membrane-potential sensitive probes such as hexamethylindodicarbocyanine, and solvatochromic probes such as those synthesized by Dr. Gabor Patonay at Georgia State University (Antoine et al., 1992). Work by American Research Corporation of Virginia has demonstrated the use of solvatochromic dyes in conjunction with sorbent polymers. Solvatochromic dyes may be used to monitor changes in local solvation parameters resulting from the presence of the analyte. The development of solvatochromic dyes through formation of charge centers within the molecule is discussed by MacGregor and Weber (1981). Bathochromic shifts are expected with increased solvent polarity, when the excited state of the fluorophore is more polar than the ground state. Similarly, a hypsochromic shift is expected when the excited state is less polar than the ground state. Solvation parameters depend upon a wide range of solute-solute interactions including orientation, induction, van der Waals interactions donor-acceptor effects and hydrophobic-hydrophilic interactions. Monitoring the solvatochromism of a fluorophore embedded in a sorbent polymer is inherently selective as a result of the range of responses to alterations at the molecular level.

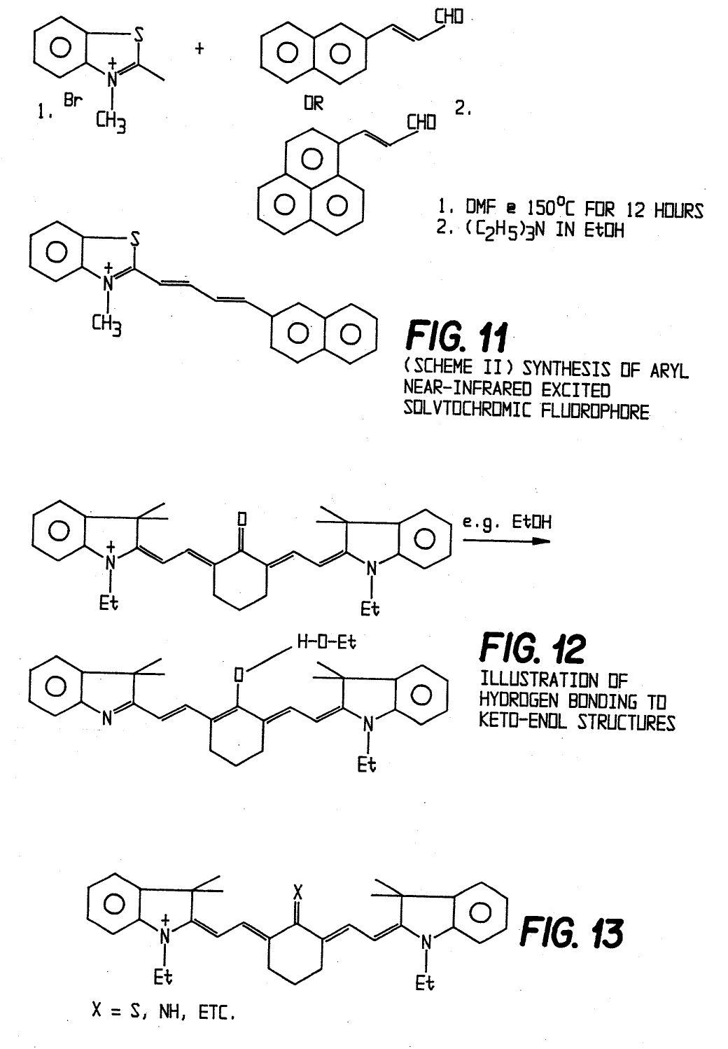

Asymmetric near infrared excited dyes can provide increased dipole moment change during laser excitation. Work at Georgia State University has shown that asymmetric dyes can be synthesized through a two-step reaction shown in FIG. 10. A “half dye” is synthesized first followed by a condensation reaction with a second heterocyclic moiety, resulting in an asymmetric dye. The dye presented in FIG. 10 has an Oxazine chromophore as well as a benzothiazolium chromophore in the same structure. Aryl solvatochromic dyes have been synthesized through a method shown in FIG. 11, previously investigated by workers at Georgia State University (Boyer et al., 1991). The absorption wavelengths of the aryl dyes can be adjusted through addition of vinyl groups to the dye structure. A dye that has been shown to be sensitive to solvent polarity and hydrogen bonding is presented in FIG. 12. The probe provided a large spectral change in response to aqueous and organic solvent media (Patonay et al., 1993). The dye does not have the typical methane conjugation due to the presence of the keto moiety. Upon hydrogen bonding to the central oxygen atom, the methine conjugation is partially reestablished resulting in significant bathochromic shift and increased near-infrared fluorescence. Other hydrogen bonding structures may be introduced to the dye structure to allow differential response to analyte binding. Several dyes that can be used for this purpose are presented in FIG. 13.

Previous work by American Research Corporation of Virginia indicated that sorbent polymers such as Nafion may be used with near-infrared dyes to detect nerve agents and simulants. While the mechanism of response is not known, it is expected that changes in the Nafion conformation resulting from absorption and hydrogen bond formation with the analyte affected the local environment of the immobilized fluorophore. Zen et al. (1992) showed that a range of hydrophobic near infrared dyes preferentially aggregated in the hydrophobic region of Nafion, thereby leading to anomalous dimerization within the matrix and concomitant reduction in fluorescence of the dye. Further increases in the sensitivity of this approach may be achieved through the creation of tethered dye molecules that will provide a means to monitor dimerization at lower dye concentrations necessary to maintain high analyte to fluorophore ratio within the polymer matrix. The concept of attaching two chromophoric materials to provide a heterodimeric molecule sensitive to its environment was reviewed by Selvin (1995). A wide range of probes based on fluorescence resonance energy transfer (FRET) was suggested by Lakowicz et al. (1993). A polarity-sensitive dye with near-infrared absorption having asymmetric chromophoric groups was prepared by Dr. Gabor Patonay (Antoine et al., 1992). The pyrenyl probe prepared by Dr. Patonay showed the feasibility of coupling aromatic materials to a near infrared excitable dye structure.

While the invention has been described with reference to specific embodiments, modifications and variations of the invention may be constructed without departing from the scope of the invention, which is defined in the following claims.

TABLE A
LSER Regression Coefficients for 14 polymers at 25 C.

| | | Polariz- | Dipo- | Hydrogen | Hydrogen | |
|---|---|---|---|---|---|---|
| | | ability, | larity, | Bond | bond | Disper- |
| Polymer | Constant, c | r | s | basicity, a | acidity, b | sion, l |
| PIB | −0.77 | −0.08 | 0.37 | 0.18 | 0.00 | 102 |
| SXPH | −0.85 | 0.18 | 1.29 | 0.56 | 0.44 | 0.89 |
| PEM | −1.65 | −1.03 | 2.75 | 4.23 | 0.00 | 0.87 |
| SXCN | −1.63 | 0.00 | 2.28 | 3.03 | 0.52 | 0.77 |
| PVTD | −0.59 | −0.02 | 0.74 | 2.44 | 0.22 | 0.92 |
| PECH | −0.75 | 0.10 | 1.63 | 1.45 | 0.71 | 0.83 |
| PVPR | −0.57 | 0.67 | 0.83 | 2.25 | 1.03 | 0.72 |
| OV202 | −0.39 | −0.48 | 1.30 | 0.44 | 0.71 | 0.81 |
| P4V | −1.33 | −1.54 | 2.49 | 1.51 | 5.88 | 0.90 |
| SXFA | −0.08 | −0.42 | 0.60 | 0.70 | 4.25 | 0.72 |
| FPOL | −1.21 | −0.67 | 1.45 | 1.49 | 4.09 | 0.81 |
| ZDOL | −0.49 | −0.75 | 0.61 | 1.44 | 3.67 | 0.71 |
| PEI | −1.60 | 0.50 | 1.52 | 7.02 | 0.00 | 0.77 |
| SXPYR | −1.94 | −0.19 | 2.43 | 6.78 | 0.00 | 1.02 |
| Note: Polymer abbreviations are as follows: PIB Poly(isobutylene), SXPH 75% phenyl-25% methylpolysilonane, PEM poly(ethylene maleate), SXCN Poly bis(cyanopropyl) siloxane, PVTD poly(vinyltetradecanal), PECH poly(epichlorohydrin), PVPR poly(vinyl propionate), OV202 poly(trifluopropyl) methyl siloxane, P4V poly(4-vinylhexafluorocumyl alcohol), | | | | | | |
| #SXFS 1-(4-hydroxy, 4-trifluoromethyl,5,5,5,-trifluoro)pentene, FPOL fluoropolyol, ZDOL Fomblin Z-dol, PEI Poly(ethyleneimine), SXPYR alkylaminopyridyl-substituted siloxane. | | | | | | |

We claim:

1. A method of detecting a chemical agent, comprising exposing a sample to a fluorescent probe apparatus comprising at least one probe, wherein said at least one probe comprises a fluorophore in a polymer, said polymer selected from the group consisting of poly(isobutylene), 75%-phenyl-25%-methylpolysiloxane, poly(epichlorhydrin), poly(vinylpropionate), poly(trifluoropropyl)methylsiloxane, poly(4-vinylhexafluorocumyl alcohol), 1-(4-hydroxy, 4-trifluoromethyl, 5,5,5-trifluoro)pentene methylpolysiloxane, fluoropolyol, perfluorinated polyether with CF₂CH₂OH groups, poly(ethyleneimine), polybis(cyanopropyl)siloxane, poly(vinyltetradecanal) and alkylaminopyridyl-substituted siloxane and said fluorophore is selected from the group consisting of oxazine 720, 1,3-bis(4-(dimethylamino-2-hydroxyphenyl)-2,4-dihydroxycyclobutenediylium dihydroxide, bis(inner salt), diethylthiadicarbocyanine iodide, hexamethylindotricarbocyanine iodide, Indocyanine Green, New Indocyanine Green, diethylthiatricarbocyanine iodide, IR-780 perchlorate and hexamethylindodicarbocyanine, and determining a change of fluorescence resulting from exposure of said fluorophore to said chemical agent.

2. The method of claim 1, wherein said polymer is poly(ethyleneimine).

3. The method of claim 1, further comprising a solvent absorbed by said polymer.

4. The method of claim 3, wherein said solvent is ethanol.

5. The method of claim 2, further comprising a solvent absorbed by said polymer.

6. The method of claim 5, wherein said solvent is ethanol.

7. The method of claim 1, wherein said fluorophore is embedded in said polymer.

8. A method of detecting a chemical agent, comprising exposing a sample to a fluorescent probe apparatus comprising at least one probe, wherein said at least one probe comprises a fluorophore in a polymer, wherein said fluorophore is selected from the group consisting of Nile blue A perchlorate, Nile red, oxazine 720, oxazine 750, 1,3-bis(4-(dimethylamino)-2-hydroxyphenyl)-2,4-dihydroxycyclobutenediylium dihydroxide, bis(inner salt), diethylthiadicarbocyanine iodide, hexamethylinotricarbocyanine iodide, Indocyanine Green, New Indocyanine Green, diethylthiatricarbocyanine iodide, IR-780 perchlorate, Methylene Blue and hexamethylindodicarbocyanine and said polymer is selected from the group consisting of poly(isobutylene), 75%-phenyl-25%-methylpolysiloxane, polybis(cyanopropyl)siloxane, poly (4-vinylhexafluorocumyl alcohol), 1-(4-hydroxy, 4-trifluoromethyl, 5,5,5,-trifluoro)pentene methylpolysiloxane, fluoropolyol, poly(vinyltetradecanal), poly(epichlorhydrin), poly(vinylpropionate), poly(trifluoropropyl) methylsiloxane, perfluorinated polyether with CF₂CH₂OH groups and alkylaminopyridyl-substituted siloxane, and determining a change of fluorescence resulting from exposure of said fluorophore to said chemical agent.

9. The method of claim 8, wherein the fluorophore is selected from the group consisting of oxazine 720, 1,3-bis(4-(diethylamino)-2-hydroxyphenyl)-2,4-dihydroxycyclobutenediylium dihydroxide, bis (inner salt), diethylthiadicarbocyanine iodide, hexamethylindotricarbocyanine iodide, Indocyanine Green, New Indocyanine Green, diethylthiatricarbocyanine iodide, IR-780 perchlorate and hexamethylindodicarbocyanine.

10. The method of claim 9, further comprising a solvent absorbed by said polymer.

11. The method of claim 10, wherein said solvent is ethanol.

12. The method of claim 8, further comprising a solvent absorbed by said polymer.

13. The method of claim 12, wherein said solvent is ethanol.

14. The method of claim 8, wherein said polymer is fluoropolyol, poly (epichlorhydrin) or poly (4-vinylhexafluorocumyl alcohol) and said fluorophore is Nile red, Nile blue A perchlorate or hexamethylindodicarbocyanine.

15. The method of claim 1, comprising at least two probes wherein each of said two probes detects a different chemical agent.

16. The method of claim 8, comprising at least two probes wherein each of said two probes detects a different chemical agent.

17. The method of claim 8, wherein said polymer is fluoropolyol.

18. The method of claim 12, wherein said polymer is poly(epichlorhydrin) and said fluorophore is Nile blue A perchlorate.

19. The method of claim 13, wherein said polymer is poly(epichlorhydrin) and said fluorophore is Nile blue A perchlorate.

20. A method of detecting a chemical agent, comprising exposing a sample to a fluorescent probe apparatus comprising at least one probe, wherein said at least one probe comprises a fluorophore in a polymer, said fluorophore selected from the group consisting of Nile blue A perchlorate, Nile red, oxazine 720, oxazine 750, 1,3-bis(4-(dimethylamino)-2-hydroxyphenyl)-2,4-dihydroxycyclobutenediylium dihydroxide, bis(inner salt), diethylthiadicarbocyanine iodide, hexamethylindotricarbocyanine iodide, Indocyanine Green, New Indocyanine Green, diethylthiatricarbocyanine iodide, IR-780 perchlorate, Methylene Blue and hexamethylindodicarbocyanine, and said polymer selected from the group consisting of poly(isobutylene), 75%-phenyl-25%-methylpolysiloxane, polybis(cyanopropyl)siloxane, poly(4-vinylhexafluorocumyl alcohol), 1-(4-hydroxy, 4-trifluromethyl, 5,5,5,-trifluoro) pentene methylpolysiloxane, poly(vinyltetradecanal), poly(epichlorhydrin), poly(vinylpropionate), poly(trifluoropropyl)methylsiloxane, fluoropolyol, perfluorinated polyether with CF₂CH₂OH groups and alkylaminopyridyl-substituted siloxane, and determining a change of fluorescence resulting from exposure of said fluorophore to said chemical agent.

21. The method of claim 20, wherein said fluorophore is embedded in said polymer.

22. The method of claim 20, wherein said polymer is fluoropolyol, poly(epichlorhydrin) or poly(4-vinylhexafluorocumyl alcohol) and said fluorophore is Nile red, Nile blue A perchlorate or hexamethylindodicarbocyanine.

23. The method of claim 20, further comprising a solvent absorbed by the polymer.

24. The method of claim 23, wherein the solvent is ethanol.

25. The method of claim 23, wherein said polymer is poly(epichlorhydrin) and said fluorophore is Nile blue A perchlorate.

26. The method of claim 24, wherein said polymer is poly(epichlorhydrin) and said fluorophore is Nile blue A perchlorate.

27. The method of claim 20, wherein the fluorophore is Nile blue A perchlorate.

28. The method of claim 20, wherein the fluorophore is selected from a group consisting of oxazine 720, 1,3-bis(4-(dimethylamino)-2-hydroxyphenyl)-2,4-dihydroxycyclobutenediylium dihydroxide, bis (inner salt), diethylthiadicarbocyanine iodide, hexamethylindotricarbocyanine iodide, Indocyanine Green, New Indocyanine Green, diethylthiatricarbocyanine iodide, IR-780 Perchlorate, and hexamethylindodicarbocyanine.

29. The method of claim 28, further comprising a solvent absorbed by the polymer.

30. The method of claim 20, wherein said fluorescent probe apparatus comprises at least two probes wherein each probe is sensitive to a different chemical agent material.

31. The method of claim 20, wherein the polymer is fluoropolyol.

32. The method of claim 20, wherein the polymer is poly (epichlorohydrin).

33. The method of claim 20, wherein the polymer is poly(epichlorohydrin) and the fluorophore is Nile blue A perchlorate.

34. A method of detecting a chemical agent, comprising exposing a sample to a fluorescent probe apparatus comprising at least one probe, wherein said at least one probe comprises a fluorophore in poly(ethylene maleate), wherein said fluorophore is selected from the gorup consisting of oxazine 720, 1,3-bis(4-(dimethylamino)-2-hydroxyphenyl)-2,4-dihydroxycyclobutenediylium dihydroxide, bis(inner salt), diethylthiadicarbocyanine iodide, hexamethylindotricarbocyanine iodide, Indocyanine Green, New Indocyanine Green, and IR-780 perchlorate, and determining a change of fluorescence resulting from exposure of said fluorophore to said chemical agent.

35. The method of claim 34, wherein said fluorophore is embedded in said poly(ethylene maleate).
